(19) United States
(12) Patent Application Publication
(10) Pub. No.: US 2026/0314705 A1
(43) Pub. Date: Oct. 15, 2026

(54) AEROSOL GENERATING DEVICE AND HEATING CONTROL METHOD THEREFOR

(71) Applicant: SMOORE INTERNATIONAL HOLDINGS LIMITED, Grand Cayman (KY)

(72) Inventors: Kunren YIN, Shenzhen (CN); Feng LIANG, Shenzhen (CN)

(73) Assignee: SMOORE INTERNATIONAL HOLDINGS LIMITED, Grand Cayman (KY)

(21) Appl. No.: 19/680,162

(22) Filed: May 18, 2026

Related U.S. Application Data
(63) Continuation of application No. PCT/CN2024/125724, filed on Oct. 18, 2024.

(30) Foreign Application Priority Data
Nov. 17, 2023 (CN) 202311537201.0

(51) Int. Cl. A24F 40/57; A24F 40/46; A24F 40/53; H05B 6/64

(52) U.S. Cl. CPC A24F 40/57; A24F 40/46; A24F 40/53; H05B 6/645

(57) ABSTRACT

An aerosol generating device and a heating control method are provided. The heating control method includes detecting a heating start signal for an aerosol generating substrate. The heating element is controlled to heat the aerosol generating substrate from a current temperature to a preheating temperature and be maintained until a puffing action occurs. When a puffing action occurs, the heating element is controlled to heat the aerosol generating substrate from the preheating temperature to a corresponding target temperature and be maintained until a next puffing action occurs. The target temperature corresponds to a current puff count. The target temperature of a first puff is greater than the preheating temperature and less than the target temperature of another puff.

### RELATED APPLICATIONS

The present application is a continuation of International Patent Application No. PCT/CN2024/125724, filed on Oct. 18, 2024, which claims priority to Chinese Patent Application No. 202311537201.0 filed on Nov. 17, 2023. The entire disclosure of the prior applications is hereby incorporated by reference.

### TECHNICAL FIELD

This disclosure relates to the technical field of aerosol generating, and in particular, to an aerosol generating device and a heating control method therefor.

### BACKGROUND

For quick generation of aerosols, a heating mode for an existing aerosol generating device is required to heat an aerosol generating substrate to a relatively high temperature, such as above 250°C, in a preheating stage (0-T1), and then cool down the aerosol generating substrate to prevent a burnt flavor, as shown in FIG. 1. In some aerosol generating devices, the heating temperature rises again after the cooling stage, so as to prevent a decrease in the aerosol amount in the later stage. However, in practical applications, it has been found that when a user takes a first puff, aerosols are often excessively hot, resulting in a burning sensation in the mouth of the user.

### SUMMARY

The technical problem to be solved in this disclosure is to provide an aerosol generating device and a heating control method therefor to overcome at least one shortcoming in the related technology mentioned in the foregoing background section: in the aerosol generating device, an aerosol generating substrate is heated to a relatively high temperature in a preheating stage. When a user takes a first puff, aerosols are often excessively hot, resulting in a burning sensation in the mouth.

A technical solution used in this disclosure to solve the technical problem is as follows: a heating control method for an aerosol generating device. The aerosol generating device includes a heating element. The heating element is a microwave heating element or a laser heating element.

The heating control method includes the following steps:
a preheating step: when a heating start signal for an aerosol generating substrate accommodated in the aerosol generating device is detected, controlling the heating element to heat the aerosol generating substrate, to cause the temperature of the aerosol generating substrate to increase from a current temperature to a preheating temperature and be maintained until a puffing action occurs; and
a puffing and heating step: when it is detected that the puffing action occurs, controlling the heating element to heat the aerosol generating substrate, to cause the temperature of the aerosol generating substrate to reach a corresponding target temperature and be maintained until a next puffing action occurs.

The target temperature corresponds to a current puff count. The target temperature of a first puff is greater than the preheating temperature and less than or equal to the target temperature of another puff.
the target temperature of an ith puff is greater than or equal to the target temperature of an (i–1)th puff, i=2, 3, 4,..., N, and N represents a puff count threshold. a difference between the target temperature of the first puff and the preheating temperature is greater than
a difference between the target temperature of a second puff and the target temperature of the first puff.
the temperature range of the preheating temperature is 100°C to 188°C.
the puffing and heating step includes:
a temperature rise sub-step: when it is detected that the puffing action occurs, controlling the heating element to heat the aerosol generating substrate at first preset power within a first preset time period; and
a temperature control sub-step: at the end of the first preset time period, if it is determined that the temperature of the aerosol generating substrate is less than the target temperature, controlling the heating element to heat the aerosol generating substrate at second preset power within a second preset time period, and if it is determined that the temperature of the aerosol generating substrate is greater than or equal to the target temperature, controlling the heating element to stop heating the aerosol generating substrate within a third preset time period, wherein the second preset power is less than the first preset power.

This disclosure further provides an aerosol generating device, including:
a heating element, wherein the heating element is a microwave heating element or a laser heating element; and
a control assembly, wherein the control assembly is configured to:
when a heating start signal for the aerosol generating substrate accommodated in the aerosol generating device is detected, control the heating element to heat the aerosol generating substrate, to cause the temperature of the aerosol generating substrate to increase from a current temperature to a preheating temperature and be maintained until a puffing action occurs; and
when it is detected that the puffing action occurs, control the heating element to heat the aerosol generating substrate, to cause the temperature of the aerosol generating substrate to reach a corresponding target temperature and be maintained until a next puffing action occurs.

The target temperature corresponds to a current puff count. The target temperature of a first puff is greater than the preheating temperature and less than or equal to the target temperature of another puff.
the target temperature of an i^{th} puff is greater than or equal to the target temperature of an (i–1)^{th} puff, i=2, 3, 4,..., N, and N represents a puff count threshold.
the temperature range of the preheating temperature is 100°C to 188°C.
the microwave heating element is on the outer circumference of or within the aerosol generating substrate.
an infrared heating element. The infrared heating element is on the outer circumference of or within the aerosol generating substrate.

The following beneficial effects are achieved:

When the heating start signal for the aerosol generating substrate accommodated in the aerosol generating device is detected, the microwave heating element or the laser heating element is controlled to heat the aerosol generating substrate, to cause the temperature of the aerosol generating substrate to increase from the current temperature to the preheating temperature and be maintained until the puffing action occurs. Later, when it is detected that the puffing action occurs, the microwave heating element or the laser heating element is controlled to heat the aerosol generating substrate, to cause the temperature of the aerosol generating substrate to reach the corresponding target temperature and be maintained until the next puffing action occurs. The target temperature corresponds to the current puff count. Since the target temperature of the first puff is greater than the preheating temperature and less than the target temperature of another puff, the content and temperature of water vapor aerosols during the first puff can be effectively reduced, thus avoiding the problem of a burning sensation in the mouth when a user takes the first puff, and enhancing the puffing experience.

### BRIEF DESCRIPTION OF THE DRAWINGS

This application is further described below with reference to the accompanying drawings and the embodiments. In the accompanying drawings:

FIG. 1 is a schematic diagram of a curve of puffing duration and the temperature of an aerosol generating substrate in the related technology;

FIG. 2 is a flowchart of an embodiment in a heating control method for an aerosol generating device according to this disclosure;

FIG. 3 is a schematic diagram of a temperature control curve in an example of this disclosure;

FIG. 4 is a schematic diagram of a temperature control curve and a temperature detection curve in an example of this disclosure;

FIG. 5 is a logic structural diagram of an example of an aerosol generating device according to this disclosure;

FIG. 6 is a schematic diagram of a structure of a microwave heating element in an example of this disclosure;

FIG. 7 is an exploded view of the microwave heating element shown in FIG. 6;

FIG. 8 is a cross-sectional view of a radiation element of the microwave heating element shown in FIG. 6 being located on the inner side of a receiving cavity;

FIG. 9 is a cross-sectional view of cooperation between a microwave heating element and an aerosol generating product in an example of this disclosure;

FIG. 10 is a schematic diagram of a structure of cooperation between an aerosol generating device and an aerosol generating product in an example of this disclosure; and

FIG. 11 is a cross-sectional view of the aerosol generating device shown in FIG. 10.

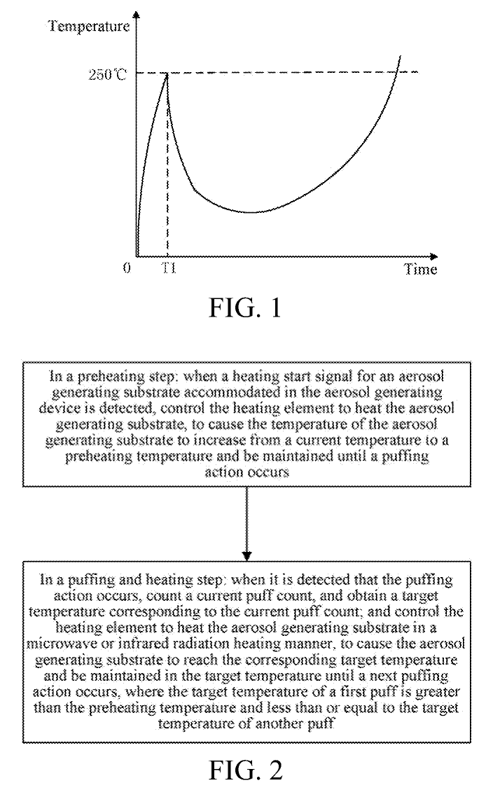

### DETAILED DESCRIPTION

To provide a clearer understanding of the technical features, objectives, and effects of this disclosure, specific implementations of this disclosure are described in detail with reference to the accompanying drawings.

It should be noted that the flowcharts shown in the accompanying drawings are only exemplary illustrations and do not necessarily include all the content and operations/steps, nor does they have to be executed in the order described. For example, some operations/steps can be decomposed, while other operations/steps can be merged or partially merged, so an actual execution order may change based on actual situations.

The block diagrams shown in the accompanying diagrams are merely functional entities and may not necessarily correspond to physically independent entities. That is, these functional entities can be implemented in a software form, or in different networks and/or processor devices and/or microcontroller devices.

The boiling point of water in an aerosol generating substrate is 100°C. The boiling point of propylene glycol (PG) is 188.2°C. The boiling point of vegetable glycerin (VG) is 290°C. The boiling point of nicotine is 247°C. To rapidly generate sufficient aerosols by a related aerosol generating device, the aerosol generating substrate needs to be heated to 250°C or above in a preheating stage. Moisture in the aerosol generating substrate can rapidly evaporate. Water vapor with the excessively high temperature is mixed with aerosols can cause a burning sensation in the mouth during a first puff, and the aerosol generating device will also be hot.

Therefore, if the temperature of the aerosol generating substrate from the start of preheating to prior to the end of the first puff is less than or equal to the temperatures of the aerosol generating substrate during other puffs in the entire process, it helps mitigate the problem that the aerosols during the first puff are excessively hot. Thus, one example of this disclosure discloses a heating control method for an aerosol generating device. The aerosol generating device includes a heating element for heating the aerosol generating substrate. The heating element is a microwave heating element or a laser heating element, so that the atomization stability is good and an atomization flavor is good.

In some examples, the aerosol generating substrate is removably accommodated in the aerosol generating device. The aerosol generating substrate can be a columnar aerosol generating product. Specifically, the aerosol generating substrate may be a solid material made from plant leaves and/or stems. Furthermore, an aroma component can be further added into the solid material. It can be understood in some other examples, the aerosol generating substrate may be a sheet-like or tubular aerosol generating product, without limitation.

As shown in FIG. 2, the heating control method for the aerosol generating device includes a preheating step and a puffing and heating step, specifically as follows:

In a preheating step: when a heating start signal for an aerosol generating substrate accommodated in the aerosol generating device is detected, the heating element is controlled to heat the aerosol generating substrate, to cause the temperature of the aerosol generating substrate to increase from a current temperature to a preheating temperature and be maintained until a puffing action occurs. The current temperature may be the room temperature or an outdoor ambient temperature, based on the current operating state of the aerosol generating device. Under some conditions, if the aerosol generating device is in the continuous operating state, the current temperature may be slightly greater than the room temperature or the ambient temperature.

Specifically, the aerosol generating device further includes a temperature measurement element configured to measure the temperature of the heating element. After the aerosol generating substrate is inserted into the aerosol generating device, the heating start signal generated by a user pressing a button or clicking/tapping a touch screen can be detected, thus starting preheating. The heating element is controlled to heat the aerosol generating substrate to obtain, in real time, the temperature of the heating element that is measured by the temperature measurement element as the temperature of the aerosol generating substrate. Whether the temperature reaches the preheating temperature is determined. If the temperature reaches the preheating temperature, the preheating is completed, and the heating element is controlled to be maintained in the preheating temperature until the puffing action occurs. If the temperature does not reach the preheating temperature, the heating element is continued to be controlled to heat the aerosol generating substrate.

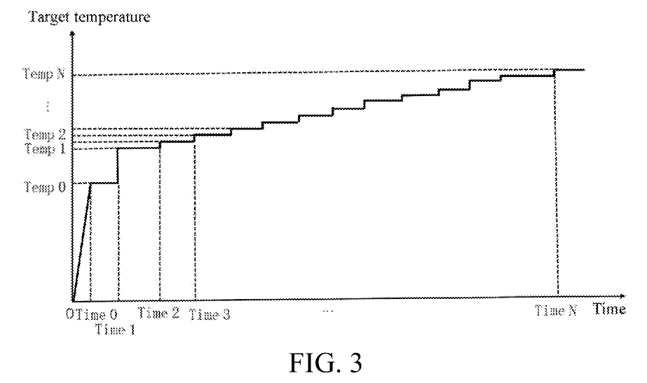

In some examples, as shown in FIG. 3, 0 to Time0 refers to the preheating stage. Time0 represents time of the end of the preheating, and the preheating stage lasts for 0 to 4 S. Temp0 represents the preheating temperature. The temperature range of the preheating temperature is 100°C to 188°C, 115°C to 125°C. It can be understood that in some other examples, the preheating stage may last for 0 to 6 S or any other time periods, and the preheating temperature may be 120°C or any other temperatures within a preheating temperature range of 100°C to 188°C, without limitation.

Compared to heating via a resistor or electromagnetic equipment, this disclosure has the relatively long preheating time, for example, around 20 S, and has the relatively high preheating temperature, such as 300°C to 450°C. In addition, the temperature rise rate and the temperature drop rate are relatively low. Therefore, when the related aerosol generating device heats the aerosol generating substrate twice consecutively, namely, when a user inserts a second aerosol generating substrate after exhausting a first aerosol generating substrate, the sustained high temperature of the heating element in the aerosol generating device during the heating on the aerosol generating substrate for the second time often causes a burning sensation in the mouth of the user taking the first puff on the aerosols.

The heating element in this example is a microwave heating element or a laser heating element, featuring a rapid temperature rise rate. The temperature can rapidly increase to the preheating temperature within 0 to 4 S. Meanwhile, the heating element also has a rapid temperature drop rate. Even if the user inserts the second aerosol generating substrate after exhausting the first aerosol generating substrate, the heating element in the aerosol generating device will be rapidly cooled. When the aerosol generating substrate is heated for the second time, the preheating stage with the relatively low temperature will be executed, so that the aerosols during the first puff taken by the user will not cause the burning sensation in the mouth.

In a puffing and heating step: when it is detected that the puffing action occurs, the heating element is controlled to heat the aerosol generating substrate, to cause the temperature of the aerosol generating substrate to reach a corresponding target temperature and be maintained until a next puffing action occurs. The target temperature corresponds to a current puff count, and the target temperature of a first puff is greater than the preheating temperature and less than or equal to the target temperature of another puff. In addition, the target temperature of an i^{th} puff is greater than or equal to the target temperature of an (i–1)^{th} puff, i=2, 3, 4,..., N, and N represents a puff count threshold.

Specifically, during the puffing of a user, an airflow sensor in the aerosol generating device detects a change in the air pressure of an airflow, thereby detecting the occurrence of the puffing action and the end of the puffing action. When it is detected that the puffing action occurs, the heating element is controlled to heat the aerosol generating substrate to obtain, in real time, the temperature of the heating element that is measured by the temperature measurement element as the temperature of the aerosol generating substrate. Whether the temperature reaches the target temperature is determined. If the temperature reaches the target temperature, the heating is completed, and the heating element is controlled to be maintained in the target temperature until the next puffing action occurs. If the temperature does not reach the target temperature, the heating element is continued to be controlled to heat the aerosol generating substrate.

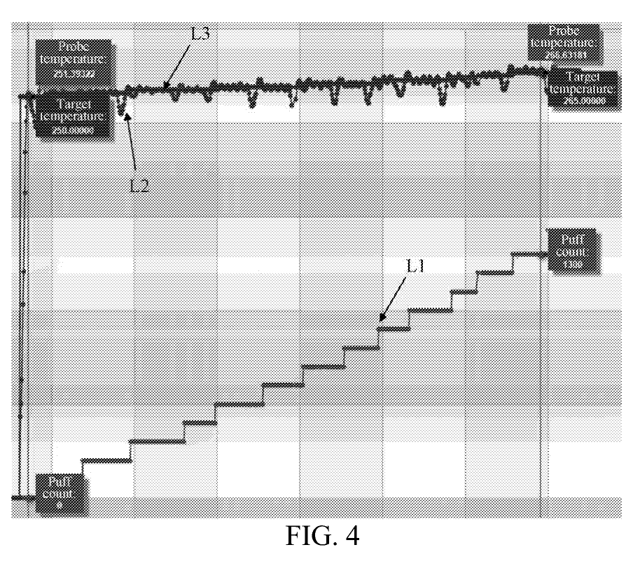

In an aspect, as shown in Table 1, FIG. 3, and FIG. 4, the following Table 1 shows a correspondence relationship between the current puff count and the target temperature of the aerosol generating substrate. In FIG. 4, curve L1 represents a puff count curve, L2 represents a temperature curve of the heating element (a probe), and L3 represents a target temperature curve. The target temperature for the first puff is greater than the preheating temperature and less than the target temperature of another puff. In addition, the target temperature of the i^{th} puff is greater than or equal to the target temperature of the (i–1)^{th} puff, i=3, 4,..., N, and N represents the puff count threshold. Specifically, from the start of preheating to prior to the end of the first puff, the temperature of the aerosol generating substrate is less than the temperatures of the aerosol generating substrate during other puffs in the entire process. Then, starting from a second puff, the temperature is maintained or rises puff by puff. In later stages, since the moisture in the aerosol generating substrate decreases, even if the aerosol generating substrate is heated to a relatively high temperature, only a relatively small amount of water vapor is generated, so that no burning sensation in the mouth will be caused in the later stages. In addition, a difference between the target temperature of the first puff and the preheating temperature is greater than a difference between the target temperature of a second puff and the target temperature of the first puff. In some examples, the difference between the target temperature of the first puff and the preheating temperature ranges from100°C to 180°C, preferably 130°C, while the difference between the target temperature of the second puff and the target temperature of the first puff ranges from 0°C to 20°C, preferably 2°C. It can be understood that in some other examples, the difference between the target temperature of the first puff and the preheating temperature is 150°C or any other temperatures within the difference range of 100°C to 180°C, and the difference between the target temperature of the second puff and the target temperature of the first puff is 3°C or any other temperatures within the difference range of 0°C to 20°C, without limitation.

As shown in FIG. 3, Time1 to TimeN refers to duration during which the occurrence of the puffing action is detected. In some examples, N is 14. It can be understood that in some other examples, N is 20 or any other numbers, without limitation. Temp1 represents the target temperature of the first puff, and Temp2 represents the target temperature of the second puff, where (Temp1-Temp0)>(Temp2-Temp1). When it is detected that the puffing action occurs, since the heating element is the microwave heating element or the laser heating element, which features a rapid temperature rise rate, the temperature can rapidly increase to the target temperature within about 0.5 S, for example, from Temp0 to Temp1. The target temperature in the later stages is maintained or rises puff by puff. This helps the release of effective ingredients of the aerosol generating substrate and enhance the consistency of flavor. If the temperature remains consistent in each later puff, the flavor of aerosols in the later stages will become lighter.

In some examples, as shown in FIG. 3, the puffing and heating step includes:

In a temperature rise sub-step: when it is detected that the puffing action occurs, the heating element is controlled to heat the aerosol generating substrate at first preset power within a first preset time period.

In a temperature control sub-step: at the end of the first preset time period, if it is determined that the temperature of the aerosol generating substrate is less than the target temperature, the heating element is controlled to heat the aerosol generating substrate at second preset power within a second preset time period, and if it is determined that the temperature of the aerosol generating substrate is greater than or equal to the target temperature, the heating element is controlled to stop heating the aerosol generating substrate within a third preset time period. The second preset power is less than the first preset power. The second preset time period and the third preset time period are preferably the same. Certainly, they may be different as well. In addition, it should be further noted that remaining time obtained by subtracting constant-power heating time (the first preset time period, such as 350 ms) from duration (such as 1 to 2 s) of a puffing action is much greater than a temperature measurement cycle (such as 20 to 30 ms), so that in the temperature control sub-step, temperature determination and power adjustment can be performed cyclically for multiple times. For example, if the duration of a puffing action of a user is 1 S, the first preset time period is 350 ms, the corresponding remaining time is 650 ms, and the temperature measurement cycle is 30 ms, temperature determination and power adjustment will be performed for probably 22 times in the temperature control sub-step.

In this example, when a control assembly controls the heating element, the constant-power (the first preset power) heating is first performed for a period of time (the first preset time period), and the temperature determination and the power adjustment are then performed cyclically. Therefore, compared with a traditional proportional-integral-derivative (PID) control solution, in which a differentiator is sensitive to a high-frequency signal generated by the microwave heating element or the laser heating element and easily amplifies a noise signal, the control solution of this example can reduce the noises of the aerosol generating device.

In an aspect, the first preset time period is, for example, 350 ms. The second preset time period and the third preset time period are respectively, for example, 30 ms. The first preset power may be the maximum output power, for example, 20 W, and the second preset power may be, for example, 10 W. In this way, when it is detected that the puffing action occurs, the heating element is first controlled to perform heating at the constant power of 20 W for 350 ms, so that the temperature of the aerosol generating substrate rises. Then, the temperature starts to be measured once every 30 ms. If it is determined that the temperature of the aerosol generating substrate is less than the target temperature, the heating element is controlled to perform heating at the constant power of 10 W for 30 ms. If it is determined that the temperature of the aerosol generating substrate is greater than or equal to the target temperature, the heating is stopped for 30 ms. In this way, the temperature measurement and the power adjustment are repeatedly and cyclically performed until the end of the puffing action is detected. It should be noted that although the heating is stopped when it is determined that the temperature of the aerosol generating substrate greater than or equal to the target temperature, this process is a cycling process at an ms level. Once it is determined that the temperature of the aerosol generating substrate is less than the target temperature, heating is performed again. Therefore, this may be approximated that the temperature of the aerosol generating substrate reaches the corresponding target temperature and is maintained.

In an aspect, the first preset time period is, for example, 450 ms. The second preset time period is, for example, 30 ms. The third preset time period is, for example, 20 ms. The first preset power may be the maximum output power, for example, 20 W, and the second preset power may be, for example, 10 W. In this way, when it is detected that the puffing action occurs, the heating element is first controlled to perform heating at the constant power of 20 W for 450 ms, so that the temperature of the aerosol generating substrate rises. Then, the temperature starts to be measured. If it is determined that the temperature of the aerosol generating substrate is less than the target temperature, the heating element is controlled to perform heating at the constant power of 10 W for 30 ms. If it is determined that the temperature of the aerosol generating substrate is greater than or equal to the target temperature, the heating is stopped for 20 ms. In this way, the temperature measurement and the power adjustment are repeatedly and cyclically performed until the end of the puffing action is detected.

In an aspect, before the puffing and heating step, the heating control method further includes a calculation step, specifically as follows:

In the calculation step: when it is detected that the puffing action occurs, the current puff count is counted, such as the first puff, the second puff, a third puff, or the like, and the target temperature corresponding to the current puff count is obtained.

In an aspect, the heating control method for the aerosol generating device further includes a heating stop step, specifically as follows:

In the heating stop step: whether the current puff count reaches the puff count threshold is determined. The puff count threshold is, for example, 10 to 16. If the current puff count reaches the puff count threshold, the heating element is controlled to stop heating the aerosol generating substrate. If the current puff count does not reach the puff count threshold, the heating element is continued to be controlled to heat the aerosol generating substrate, so that the aerosol generating substrate is maintained in the target temperature corresponding to the current puff count until the next puffing action occurs.

In an aspect, the heating control method for the aerosol generating device further includes a timing step and a heating stop step, specifically as follows:

In the timing step, timing starts when the heating start signal is detected, and accumulated heating duration is counted when the end of the puffing action is detected.

In the heating stop step: whether the accumulated heating duration reaches a heating duration threshold is determined. For example, the heating duration threshold is, for example, 4 min to 60 min. If the accumulated heating duration reaches the heating duration threshold, the heating element is controlled to stop heating the aerosol generating substrate. If the accumulated heating duration does not reach the heating duration threshold, the heating element is continued to be controlled to heat the aerosol generating substrate, so that the aerosol generating substrate is maintained in the target temperature corresponding to the current puff count until the next puffing action occurs.

In an aspect, when the end of the puffing action is detected, if it is determined that a time interval after the end of the puffing action is greater than a preset threshold or when a heating stop signal is detected, the heating element is controlled to stop heating the aerosol generating substrate. If a user intends to take a puff again subsequently, the preheating step and the puffing and heating step are re-executed.

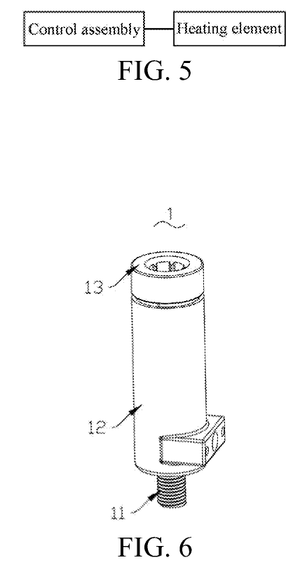

As shown in FIG. 5, an aerosol generating device, including a heating element and a control assembly. The heating element is a microwave heating element or a laser heating element, which is configured to heat an aerosol generating substrate. The control assembly is configured to:
when a heating start signal for the aerosol generating substrate accommodated in the aerosol generating device is detected, control the heating element to heat the aerosol generating substrate, to cause the temperature of the aerosol generating substrate to increase from a current temperature to a preheating temperature and be maintained until a puffing action occurs; and
when it is detected that the puffing action occurs, control the heating element to heat the aerosol generating substrate, to cause the temperature of the aerosol generating substrate to reach a corresponding target temperature and be maintained until a next puffing action occurs.

The target temperature corresponds to a current puff count, and the target temperature of a first puff is greater than the preheating temperature and less than or equal to the target temperature of another puff.

Specifically, the aerosol generating device further includes a temperature measurement element, a heating start detection assembly, and a puffing detection assembly. The temperature measurement element is configured to measure the temperature of the heating element. The heating start detection assembly is configured to detect the heating start signal and a heating stop signal for the aerosol generating substrate accommodated in the aerosol generating device. The puffing detection assembly is configured to detect the occurrence and end of the puffing action, such as an airflow sensor. After the aerosol generating substrate is inserted into the aerosol generating device, the heating start detection assembly can detect the heating start signal generated by a user pressing a button or clicking/tapping a touch screen, thus starting preheating. The control assembly is configured to: control the heating element to heat the aerosol generating substrate to obtain, in real time, the temperature of the heating element that is measured by the temperature measurement element as the temperature of the aerosol generating substrate; determine whether the temperature reaches the preheating temperature; if the temperature reaches the preheating temperature, complete the preheating, and control the heating element to be maintained in the preheating temperature until the puffing action occurs; and if the temperature does not reach the preheating temperature, continue to control the heating element to heat the aerosol generating substrate.

During the puffing of a user, the puffing detection assembly in the aerosol generating device detects a change in the air pressure of an airflow, thereby detecting the occurrence of the puffing action and the end of the puffing action. When the puffing detection assembly detects that the puffing action occurs, the control assembly is configured to: control the heating element to heat the aerosol generating substrate to obtain, in real time, the temperature of the heating element that is measured by the temperature measurement element as the temperature of the aerosol generating substrate; determine whether the temperature reaches the target temperature; if the temperature reaches the target temperature, complete the heating, and control the heating element to be maintained in the target temperature until the next puffing action occurs; and if the temperature does not reach the target temperature, continue to control the heating element to heat the aerosol generating substrate.

In an aspect, the target temperature of an i^{th} puff is greater than or equal to the target temperature of an (i–1)^{th} puff, i=2, 3, 4,..., N, and N represents a puff count threshold. the target temperature of the first puff is less than the target temperature of another puff. The target temperature of the i^{th} puff is greater than or equal to the target temperature of the (i–1)^{th} puff, i= 3, 4,..., N. Specifically, from the start of preheating to prior to the end of the first puff, the temperature of the aerosol generating substrate is less than the temperatures of the aerosol generating substrate during other puffs in the entire process. Then, starting from a second puff, the temperature is maintained or rises puff by puff. In later stages, since the moisture in the aerosol generating substrate decreases, even if the aerosol generating substrate is heated to a relatively high temperature, only a relatively small amount of water vapor is generated, so that no burning sensation in the mouth will be caused in the later stages.

In an aspect, a difference between the target temperature of the first puff and the preheating temperature is greater than a difference between the target temperature of a second puff and the target temperature of the first puff.

In an aspect, the temperature range of the preheating temperature is 100°C to 188°C, preferably 115°C to 125°C.

In an aspect, when it is detected that the puffing action occurs, the controlling the heating element to heat the aerosol generating substrate, to cause the temperature of the aerosol generating substrate to reach a corresponding target temperature and be maintained until a next puffing action occurs includes:
when it is detected that the puffing action occurs, controlling the heating element to heat the aerosol generating substrate at first preset power within a first preset time period; and

at the end of the first preset time period, if it is determined that the temperature of the aerosol generating substrate is less than the target temperature, controlling the heating element to heat the aerosol generating substrate at second preset power within a second preset time period, and if it is determined that the temperature of the aerosol generating substrate is greater than or equal to the target temperature, controlling the heating element to stop heating the aerosol generating substrate within a third preset time period. The second preset power is less than the first preset power. The second preset time period and the third preset time period are preferably the same. Certainly, they may be different as well. In addition, it should be further noted that remaining time obtained by subtracting constant-power heating time (the first preset time period, such as 350 ms) from duration (such as 1 to 2 s) of a puffing action is much greater than a temperature measurement cycle (such as 20 to 30 ms), so that in this stage, temperature determination and power adjustment can be performed cyclically for multiple times. For example, if the duration of a puffing action of a user is 1 S, the first preset time period is 350 ms, the corresponding remaining time is 650 ms, and the temperature measurement cycle is 30 ms, temperature determination and power adjustment will be performed for probably 22 times in this stage.

In this embodiment, when a control assembly controls the heating element, the constant-power (the first preset power) heating is first performed for a period of time (the first preset time period), and the temperature determination and the power adjustment are then performed cyclically. Therefore, compared with a traditional proportional-integral-derivative (PID) control solution, in which a differentiator is sensitive to a high-frequency signal generated by the microwave heating element or the laser heating element and easily amplifies a noise signal, the control solution of this embodiment can reduce the noises of the aerosol generating device.

In an aspect, the first preset time period is, for example, 350 ms. The second preset time period and the third preset time period are respectively, for example, 30 ms. The first preset power may be the maximum output power, for example, 20 W, and the second preset power may be, for example, 10 W. In this way, when it is detected that the puffing action occurs, the heating element is first controlled to perform heating at the constant power of 20 W for 350 ms, so that the temperature of the aerosol generating substrate rises. Then, the temperature starts to be measured once every 30 ms. If it is determined that the temperature of the aerosol generating substrate is less than the target temperature, the heating element is controlled to perform heating at the constant power of 10 W for 30 ms. If it is determined that the temperature of the aerosol generating substrate is greater than or equal to the target temperature, the heating is stopped for 30 ms. In this way, the temperature measurement and the power adjustment are repeatedly and cyclically performed until the end of the puffing action is detected. It should be noted that although the heating is stopped when it is determined that the temperature of the aerosol generating substrate greater than or equal to the target temperature, this process is a cycling process at an ms level. Once it is determined that the temperature of the aerosol generating substrate is less than the target temperature, heating is performed again. Therefore, this may be approximated that the temperature of the aerosol generating substrate reaches the corresponding target temperature and is maintained.

In an aspect, the first preset time period is, for example, 450 ms. The second preset time period is, for example, 30 ms. The third preset time period is, for example, 20 ms. The first preset power may be the maximum output power, for example, 20 W, and the second preset power may be, for example, 10 W. In this way, when it is detected that the puffing action occurs, the heating element is first controlled to perform heating at the constant power of 20 W for 450 ms, so that the temperature of the aerosol generating substrate rises. Then, the temperature starts to be measured. If it is determined that the temperature of the aerosol generating substrate is less than the target temperature, the heating element is controlled to perform heating at the constant power of 10 W for 30 ms. If it is determined that the temperature of the aerosol generating substrate is greater than or equal to the target temperature, the heating is stopped for 20 ms. In this way, the temperature measurement and the power adjustment are repeatedly and cyclically performed until the end of the puffing action is detected.

In an aspect, the control assembly is configured to: when it is detected that the puffing action occurs, count the current puff count, such as the first puff, the second puff, a third puff, or the like, and obtain the target temperature corresponding to the current puff count.

In an aspect, the control assembly is configured to: determine whether the current puff count reaches the puff count threshold, where the puff count threshold is, for example, 10 to 16; if the current puff count reaches the puff count threshold, control the heating element to stop heating the aerosol generating substrate; and if the current puff count does not reach the puff count threshold, continue to control the heating element to heat the aerosol generating substrate, so that the aerosol generating substrate is maintained in the target temperature corresponding to the current puff count until the next puffing action occurs.

In an aspect, the control assembly is configured to: start timing when the heating start signal is detected, and count accumulated heating duration when the end of the puffing action is detected; determine whether the accumulated heating duration reaches a heating duration threshold, where the heating duration threshold is, for example, 4 min to 60 min; if the accumulated heating duration reaches the heating duration threshold, control the heating element to stop heating the aerosol generating substrate; and if the accumulated heating duration does not reach the heating duration threshold, continue to control the heating element to heat the aerosol generating substrate, so that the aerosol generating substrate is maintained in the target temperature corresponding to the current puff count until the next puffing action occurs.

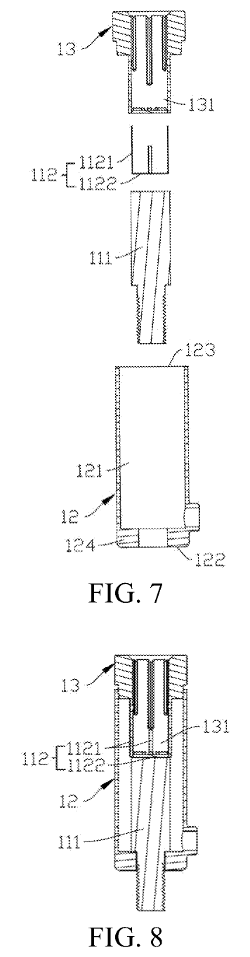

In an aspect, the microwave heating element is on the outer circumference of the aerosol generating substrate. Specifically, as shown in FIG. 6, the aerosol generating device includes a microwave heating element 1 and a microwave generating element (not shown). The microwave heating element 1 includes an inner conductor unit 11, an outer conductor unit 12, a receiving seat 13, and a microwave feed unit (not shown). As shown in FIG. 7 and FIG. 8, the outer conductor unit 12 has a cavity 121. The inner conductor unit 11 is disposed within the cavity 121 of the outer conductor unit 12 and can be in good ohmic contact with the outer conductor unit 12. The receiving seat 13 is configured to receive an aerosol generating product. The microwave feed unit is configured to feed microwaves generated by the microwave generating element into the outer conductor unit 12 and the inner conductor unit 11. The microwave heating element 1 can form a microwave field after the microwaves are fed. The microwave field surrounds the outer circumference of the aerosol generating product. This microwave field can act on the aerosol generating product to achieve microwave heating on the aerosol generating product.

As shown in FIG. 7 and FIG. 8, the outer conductor unit 12 is cylindrical, having a closed end 122 and an open end 123 opposite to the closed end 122. The semi-closed cavity 121 can be defined between the open end 123 and the closed end 122, and the receiving seat 13 extends into the cavity 121.

One end of the inner conductor unit 11 is connected to the closed end 122 of the outer conductor unit 12, and the inner conductor unit 11 is in ohmic contact with the closed end 122 of the outer conductor unit 12, while another end extends toward the open end 123 of the outer conductor unit 12. The receiving seat 13 is connected to the open end 123 and includes a receiving cavity 131 configured to receive the aerosol generating product. The receiving cavity 131 is disposed within the cavity 121 of the outer conductor unit 12.

The inner conductor unit 11 includes a conductor structure 111 and a radiation structure 112. The conductor structure 111 is disposed within the cavity 121, and the outer diameter of the conductor structure 111 is less than the inner diameter of the outer conductor unit 12. The conductor structure includes a fixed end and a free end that are opposite to each other. The fixed end is fixed on the outer conductor unit 12 and is in ohmic contact with the outer conductor unit 12. The conductor structure 111 mainly plays a role in microwave conduction. In an aspect, the conductor structure may be cylindrical. One end of the conductor structure away from the open end 123 of the outer conductor unit 12 is the fixed end which can be fixedly connected to the bottom 124 of the outer conductor unit 12. One end of the conductor structure close to the open end 123 is the free end which extends toward the open end 123 of the outer conductor unit 12.

The radiation structure 112 can be coupled to the free end of the conductor structure 111. The radiation structure 112 is located on the outer side of the aerosol generating product and can be disposed along the peripheral edge of the end face, opposite to the receiving seat 13, of the conductor structure 111. In an aspect, the radiation structure 112 includes at least one radiation element 1121 and a base portion 1122 connected to the at least one radiation element 1121. The radiation structure 112 is in ohmic contact with the free end of the conductor structure 111 via the base portion 1122. At least one radiation element 1121 is disposed in the circumferential direction of the base portion 1122. At least one radiation element is distributed on the inner side of the receiving cavity 131 and abuts against the inner or outer side wall surface of the receiving cavity 131, so as to cause the microwave field to be more uniformly distributed around the receiving cavity 131. When the aerosol generating product is received in the receiving cavity 131, at least one radiation element 1121 is located on the outer circumference of the aerosol generating product, to form the microwave field on the outer circumference of the aerosol generating product. It can be understood that in some other embodiments, at least two, three, or any number of radiation elements 1121 may be included. Each radiation element 1121 is a probe, without limitation.

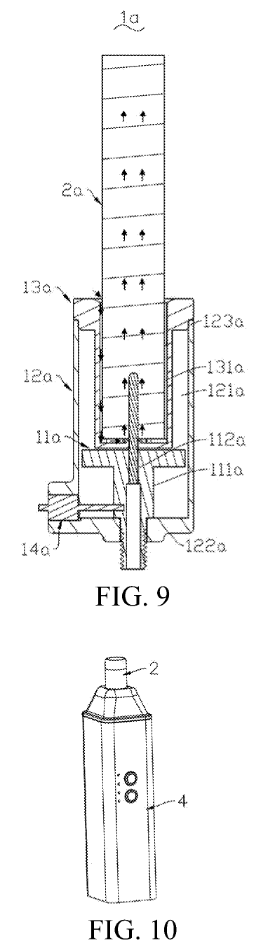

In an aspect, the microwave heating element is within the aerosol generating substrate. Specifically, as shown in FIG. 9, the aerosol generating device includes a microwave heating element 1a and a microwave generating element (not shown). The microwave heating element 1a includes an inner conductor unit 11a, an outer conductor unit 12a, a receiving seat 13a and a microwave feed unit 14a.

The outer conductor unit 12a is cylindrical, having a closed end 122a and an open end 123a opposite to the closed end 122a. A semi-closed cavity 121a can be defined between the open end 123a and the closed end 122a, and the receiving seat 13a extends into the cavity 121a.

The inner conductor unit 11a includes a conductor structure 111a and a radiation structure 112a coupled to the conductor structure 111a. In an aspect, the radiation structure 112 is a probe. The bottom of the conductor structure 111a is connected to the closed end 122a of the outer conductor unit 12a, and is in ohmic contact with the end wall of the closed end 122a, thus forming the short-circuit end of the microwave heating element 1a. One end of the radiation structure 112a is coupled to the top of the conductor structure 111a, and another end of the radiation structure 112a is located inside the cavity 121a, but is not in direct contact with the outer conductor unit 12a, thus forming the open-circuit end of the microwave heating element 1a. The microwave feed unit 14a is detachably mounted on the outer conductor unit 12a, and is configured to feed microwaves generated by the microwave generating assembly into the cavity 121a. The receiving seat 13a is fixedly or detachably mounted at the open end 123a of the outer conductor unit 12a, to define a receiving cavity 131a configured to receive an aerosol generating product 2a. One end of the radiation structure 112s away from the conductor structure 111a extends and is inserted into the receiving cavity 131a.

The aerosol generating product 2a is partially/completely inserted into the receiving cavity 131a. In this case, a part of the radiation structure 112a is inserted into the aerosol generating product 2a. When the microwave generating assembly feeds microwaves into the microwave heating element 1a through the microwave feed unit 14a, a microwave energy field can be formed at the periphery of the radiation structure 112a to heat the interior of the aerosol generating product 2a.

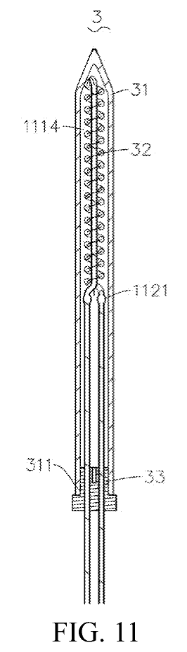

In an aspect, the laser heating element is an infrared heating element that radiates infrared ray at the outer circumference of or inside the aerosol generating substrate. The infrared ray is configured to heat the aerosol generating substrate. Specifically, as shown in FIG. 10 and FIG. 11, the aerosol generating device includes an infrared heating element 3 and a power supply assembly 4 configured to supply power to the infrared heating element 3. The infrared heating element 3 can be partially inserted into the aerosol generating product 2, or at least one infrared heating element 3 can be located at the outer circumference of the aerosol generating product 2. It can be understood that in some other embodiments, at least two, three, or any number of infrared heating elements 3 may be provided, without limitation. The infrared heating element 3 generates the infrared ray in a powered-on state to heat a substrate section of the aerosol generating product 2, to atomize the aerosol generating product and generate aerosols.

The infrared heating element 3 includes a tube body 31, a main heating element 32, and a base 33. The tube body 31 receives at least a part of the main heating element 32, to allow the infrared ray radiated by the main heating element 32 to pass through and then heat the aerosol generating product 2. The base 33 is arranged at an opening 311 of the tube body 31 to fix the tube body 31. The main heating element 32 includes a heating substrate and an infrared radiation layer disposed on the outer surface of the heating substrate. In a powered-on heating state, the heating substrate can excite the infrared radiation layer to generate and radiate infrared ray.

The following beneficial effects are achieved:

When the heating start signal for the aerosol generating substrate accommodated in the aerosol generating device is detected, the microwave heating element or the laser heating element is controlled to heat the aerosol generating substrate, to cause the temperature of the aerosol generating substrate to rise from the current temperature to the preheating temperature and be maintained until the puffing action occurs. Later, when it is detected that the puffing action occurs, the microwave heating element or the laser heating element is controlled to heat the aerosol generating substrate, to cause the temperature of the aerosol generating substrate to reach the corresponding target temperature and be maintained until the next puffing action occurs. The target temperature corresponds to the current puff count. Since the target temperature of the first puff is greater than the preheating temperature and less than the target temperature of another puff, the content and temperature of water vapor aerosols during the first puff can be effectively reduced, thus avoiding the problem of a burning sensation in the mouth when a user takes the first puff, and enhancing the puffing experience.

It can be understood that the foregoing embodiments only describe some implementations of this disclosure specifically and in detail, but cannot be construed as a limitation to the patent scope of this disclosure, but it should not be understood as a limitation to the patent scope of this disclosure. It should be pointed out that for those of ordinary skill in the art, without departing from the concept of this disclosure, several modifications and improvements can be made, and these all fall within the protection scope of this disclosure. Therefore, the protection scope of this disclosure shall be subject to the appended claims. That is, the embodiments described in "some

embodiments" can be freely combined with any embodiments. Therefore, all equivalent transformations and modifications made within the scope of the claims of this disclosure shall fall within the scope of the claims of this disclosure.

What is claimed is:

1. A heating control method for an aerosol generating device comprising:
detecting a heating start signal for an aerosol generating substrate;
controlling, based on the detected heating start signal, a heating element of the aerosol generating device to heat the aerosol generating substrate from a current temperature to a preheating temperature; and
when a puffing action occurs, controlling the heating element to heat the aerosol generating substrate from the preheating temperature to reach a target temperature and maintaining at the target temperature until a next puffing action occurs, wherein
the target temperature corresponds to a current puff count, and the target temperature of a first puff is greater than the preheating temperature and less than or equal to the target temperature of subsequent puff, and
the heating element is a microwave heating element.

2. The heating control method of claim 1, wherein
the target temperature of an i^{th} puff is greater than or equal to the target temperature of an (i–1)^{th} puff, i=2, 3, 4,..., N, and N represents a puff count threshold.

3. The heating control method of claim 1, wherein
a difference between the target temperature of the first puff and the preheating temperature is greater than a difference between a target temperature of a second puff and the target temperature of the first puff.

4. The heating control method of claim 1, wherein
the preheating temperature is range from 100°C to 188°C.

5. The heating control method of claim 4, wherein the preheating temperature is 130°C.

6. The heating control method of claim 1, wherein
when the puffing action occurs, controlling the heating element to heat the aerosol generating substrate at first preset power within a first preset time period; and
at the end of the first preset time period,
if the temperature of the aerosol generating substrate is less than the target temperature, controlling the heating element to heat the aerosol generating substrate at a second preset power within a second preset time period, and
if the temperature of the aerosol generating substrate is greater than or equal to the target temperature, controlling the heating element to stop heating the aerosol generating substrate within a third preset time period, wherein the second preset power is less than the first preset power.

7. An aerosol generating device comprising:
a heating element, wherein the heating element is a microwave heating element; and
a control assembly being configured to:
when a heating start signal is detected, control the heating element to heat an aerosol generating substrate from a current temperature to a preheating temperature; and
when a puffing action occurs, control the heating element to heat the aerosol generating substrate from the preheating temperature to a corresponding target temperature and maintaining at the target temperature until a next puffing action occurs, wherein
the target temperature corresponds to a current puff count, and the target temperature of a first puff is greater than the preheating temperature and less than or equal to the target temperature of subsequent puff.

8. The aerosol generating device of claim 7, wherein
the target temperature of an i^{th} puff is greater than or equal to the target temperature of an (i–1)^{th} puff, i=2, 3, 4,..., N, and N represents a puff count threshold.

9. The aerosol generating device of claim 7, wherein
the preheating temperature is range from 100°C to 188°C.

10. The aerosol generating device of claim 9, wherein the temperature range of the preheating temperature is 130°C.

11. The aerosol generating device of claim 7, wherein
the microwave heating element is on the outer circumference of or within the aerosol generating substrate.

12. The aerosol generating device of claim 7, wherein
when the puffing action occurs, controlling the heating element to heat the aerosol generating substrate at first preset power within a first preset time period; and
at the end of the first preset time period,
if the temperature of the aerosol generating substrate is less than the target temperature, controlling the heating element to heat the aerosol generating substrate at a second preset power within a second preset time period, and
if the temperature of the aerosol generating substrate is greater than or equal to the target temperature, controlling the heating element to stop heating the aerosol generating substrate within a third preset time period, wherein the second preset power is less than the first preset power.

13. An aerosol generating device comprising:
a heating element, wherein the heating element is infrared heating element; and
a control assembly being configured to:
when a heating start signal is detected, control the heating element to heat an aerosol generating substrate from a current temperature to a preheating temperature; and
when a puffing action occurs, control the heating element to heat the aerosol generating substrate from the preheating temperature to a corresponding target temperature and maintaining at the target temperature until a next puffing action occurs, wherein
the target temperature corresponds to a current puff count, and the target temperature of a first puff is greater than the preheating temperature and less than or equal to the target temperature of subsequent puff.

14. The aerosol generating device of claim 13, wherein
the target temperature of an i^{th} puff is greater than or equal to the target temperature of an (i–1)^{th} puff, i=2, 3, 4,..., N, and N represents a puff count threshold.

15. The aerosol generating device of claim 13, wherein
the preheating temperature is range from 100°C to 188°C.

16. The aerosol generating device of claim 15, wherein the temperature range of the preheating temperature is 130°C.

17. The aerosol generating device of claim 13, wherein
the infrared heating element is on the outer circumference of or within the aerosol generating substrate.

18. The aerosol generating device of claim 13, wherein
when the puffing action occurs, controlling the heating element to heat the aerosol generating substrate at first preset power within a first preset time period; and
at the end of the first preset time period,
if the temperature of the aerosol generating substrate is less than the target temperature, controlling the heating element to heat the aerosol generating substrate at a second preset power within a second preset time period, and
if the temperature of the aerosol generating substrate is greater than or equal to the target temperature, controlling the heating element to stop heating the aerosol generating substrate within a third preset time period, wherein the second preset power is less than the first preset power.
